(19) United States
(12) Patent Application Publication
(10) Pub. No.: US 2012/0314444 A1
(43) Pub. Date: Dec. 13, 2012

(54) FIBER OPTIC DISPLAY APPARATUS AND METHODS OF OSILLATING ILLUMINATED OPTICAL FIBERS

(76) Inventor: Thomas Mark Spangler, Charlotte, NC (US)

(21) Appl. No.: 13/327,344

(22) Filed: Dec. 15, 2011

Related U.S. Application Data
(60) Provisional application No. 61/423,572, filed on Dec. 15, 2010.

(51) Int. Cl. G09F 13/18

(52) U.S. Cl. 362/560; 362/559

(57) ABSTRACT

An optical fiber display apparatus includes a housing, a holding member moveable about a pivot point axis functionally connected to the housing, and one or more fiber optic strands having a first end attached to the holding member and a second end unrestrained. The fiber optic strands define a longitudinal axis, and the pivot point axis of the holding member is non-parallel to the fiber strands axis such that movement of the holding member about the pivot point axis causes the second unrestrained end of the fiber strand to move back and forth along a line that is non-parallel to the longitudinal fiber strand axis. A light source illuminates the first end of the fiber strands, so that light emits from the second end of the fiber strands.

### TECHNICAL FIELD AND BACKGROUND OF THE INVENTION

This application claims priority to U.S. Provisional Patent Application No. 61/423,572, filed Dec. 15, 2010, which is incorporated herein. The present invention relates to decorative fiber optic lamps, toys, and displays, and various methods of moving and manipulating illuminated fiber optical fibers.

### SUMMARY OF THE INVENTION

One object of the present invention is to provide an apparatus that can generate unique and visually stimulating light patterns and optical displays of light through the oscillation of illuminated optical fiber optic strands. These and other objects of the invention may be achieved in the preferred embodiments of the invention described below.

One embodiment of the invention comprises an optical fiber display apparatus comprising a housing, a holding member moveable about a pivot point axis functionally connected to the housing, and one or more fiber optic strands having a first end attached to the holding member and a second end unrestrained. The fiber optic strands define a longitudinal axis, and the pivot point axis of the holding member is non-parallel to the fiber strands axis such that movement of the holding member about the pivot point axis causes the second unrestrained end of the fiber strand to move back and forth along a line that is non-parallel to the longitudinal fiber strand axis. A light source illuminates the first end of the fiber strands, so that light emits from the second end of the fiber strands.

According to another embodiment of the invention, the pivot point axis of the holding member is substantially perpendicular to the fiber strand axis whereby movement of the holding member about the pivot point axis causes the second unrestrained end of the fiber strand to move back and forth along a line that is substantially perpendicular to the longitudinal fiber strand axis.

According to another embodiment of the invention, a plurality of fiber optic strands can be bundled together, and at least one of the bundled fiber optic strands is attached to the holding member.

According to another embodiment of the invention, drive means move the holding member about the pivot point axis.

According to another embodiment of the invention, the drive means can include an actuator rod, cam wheel, gear, sprocket, pulley, hand crank, motor, and/or magnet.

According to another embodiment of the invention, an actuator rod has a first end connected to the holding member and a second end mounted to a rotatable cam wheel. Rotation of the cam wheel causes the holding member to move back and forth about the pivot point axis so that the second end of the fiber strand moves back and forth.

According to another embodiment of the invention, a colored transparent filter can be positioned between the light source and the first end of the fiber strand such that the second end of the fiber strands emits at least one colored light.

According to another embodiment of the invention, the light source can comprise an incandescent bulb, light emitting diode, laser diode, mirror, prism, lens, and/or array.

According to another embodiment of the invention, the light source is positioned with the holding member.

According to another embodiment of the invention, the housing can comprise a board, plate, box, cylinder, cone, tube, and/or action figure.

According to another embodiment of the invention, an optical fiber display apparatus comprises a housing, a holding member defining a channel and moveable about a first pivot point axis functionally connected to the housing, and one or more fiber optic strands having a first end attached to the holding member and a second end unrestrained. The fiber optic strands define a longitudinal axis, and the pivot point axis of the holding member is non-parallel to the fiber strands axis such that movement of the holding member about the pivot point axis causes the second unrestrained end of the fiber strands to move back and forth along a line that is non-parallel to the longitudinal fiber strand axis. A light source illuminates the first end of the fiber strand, whereby light emits from the second end of the fiber strand.

According to another embodiment of the invention, a cam wheel is positioned within the channel defined by the holding member, and rotation of the cam wheel causes the cam wheel to contact and move the holding member.

According to another embodiment of the invention, the optical fiber display apparatus includes means for moving the cam wheel, such as a drive motor, gear, sprocket, pulley, and/or hand crank.

According to another embodiment of the invention, a second pivot point axis has a first end connected to the first pivot point axis, and a second end connected to the housing. The second pivot point axis is positioned non-parallel to the fiber strands axis, and the holding member is movable in two directions simultaneously, such that the fiber strand is movable about a two-dimensional range of motion.

According to another embodiment of the invention, the first pivot point axis and the second pivot point axis are positioned substantially parallel to the fiber strand axis.

According to another embodiment of the invention, an optical fiber display apparatus comprises a housing, a holding member moveable about a pivot point axis functionally connected to the housing, and one or more fiber optic strands having a first end attached to the holding member and a second end unrestrained. The fiber optic strands define a longitudinal axis, and the pivot point axis of the holding member is non-parallel to the fiber strand axis such that movement of the holding member about the pivot point axis causes the second unrestrained end of the fiber strand to move back and forth along a line that is non-parallel to the longitudinal fiber strand axis. A light source illuminates the first end of the fiber strands, so that light emits from the second end of the fiber strand, and at least one magnet moves the holding member.

According to another embodiment of the invention, the optical fiber display apparatus includes at least one electromagnetic wire coil, and an electrical source delivers an electrical signal through the electromagnetic wire coil to create a magnetic field causing the holding member to move about the pivot point axis in a manner that corresponds to the polarity, strength and frequency of the electrical signal.

According to another embodiment of the invention, the electrical source can comprise an amplifier, signal generator, microphone, speaker output, AC line voltage, and/or DC power supply.

### BRIEF DESCRIPTION OF THE DRAWINGS

FIG. 1 is a perspective view of an optical fiber display device according to a preferred embodiment of the invention;

FIG. 2 is a perspective view of an optical fiber display device according to another preferred embodiment of the invention;

FIG. 3 is a perspective view of an optical fiber display device according to another preferred embodiment of the invention;

FIG. 4 is a front elevation of an optical fiber display device according to another preferred embodiment of the invention;

FIG. 5 is a partial bottom plan view of the optical fiber display device of FIG. 6;

FIG. 6 is a perspective view of an optical fiber display device according to another preferred embodiment of the invention;

FIG. 7 is a schematic view of an optical fiber display device according to another preferred embodiment of the invention;

FIG. 8 is a top plan view of the optical fiber display device of FIG. 7;

FIG. 9 is a bottom plan view of the optical fiber display device of FIG. 7;

FIG. 10 is a perspective view of the optical fiber display device of FIG. 7;

FIG. 11 is a schematic view of an optical fiber display device according to another embodiment of the invention;

FIG. 12 is a schematic view of an optical fiber display device according to another embodiment of the invention;

FIG. 13 is a schematic view of an optical fiber display device according to another embodiment of the invention; and

FIG. 14 is a schematic view of an optical fiber display device according to another embodiment of the invention.

### DESCRIPTION OF THE PREFERRED EMBODIMENTS OF THE INVENTION AND BEST MODE

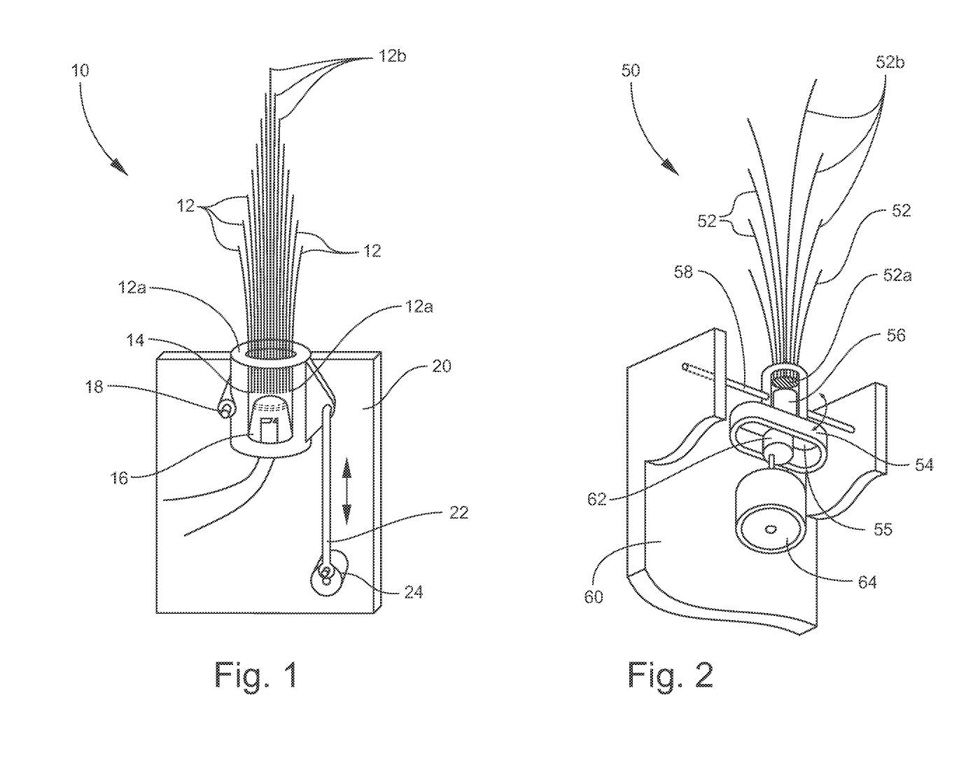

An optical fiber display device according to a preferred embodiment of the invention is illustrated in FIG. 1, and shown generally at reference numeral 10. The device 10, utilizes locomotive oscillation and comprises varying length fiber optic strands 12 tightly bound inside a rigid holder 14. The strands 12 can be individually bound within the holder 14 or bundled. One end of each strand 12 can extend slightly beyond the rigid holder 14, and is herein referred to as the illuminated end 12a of the fibers 12. The other end 12b of the fiber optic strand 12 is unrestrained and allowed to move freely about, and is herein referred to as the display end 12b of the fibers 12. The holder 14 can be contained within a rigid housing 20.

In addition to the illuminated fiber ends 12a of the fibers 12, the rigid holder 14 contains an illuminated light source 16 for the fibers 12. The light source 16 can comprise one or more of the following: incandescent bulb, light emitting diode (LED), laser diode, mirror, prism, lens, and/or array for each individual fiber 12 or bundle of fibers 12. The light source 16 can be mounted within the holder 14 and oriented in such a way as to expose and illuminate the rigidly bound fiber ends 12a, causing light to be emitted from the display end 12b of the fibers 12. The fiber holder 14 may also contain a colored transparent filter placed between the light source 16 and illuminated fibers 12 so as to add one or more colors to the fiber display while incorporating a single light source 16.

Alternatively, the light source can be affixed to the housing 20. The tightly bound illuminated fibers 12 can be exposed to and illuminated by a stationary light source, such as an incandescent bulb, LED, laser diode, mirror, prism, lens or array affixed to the rigid housing 20. As the holder 14 is moved throughout its range of motion, the illuminated fiber ends 12a are exposed to the stationary light source, causing light to be emitted from the display end 12b of the fibers 12. This configuration allows for color changes within individual fibers 12 and bundles of fibers 12 as they sweep across a multi-colored light source, and reduces the weight of the moving rigid holder 14.

The rigid holder 14 is freely secured to a pivot point axis 18 attached to the housing 20. Alternatively, the pivot point axis 18 can be an integral part of the housing 20. The pivot point axis 18 within the rigid fiber holder 14 is positioned non-parallel to the axis of fibers 12 within the rigid holder 14. Preferably, the axis 18 within the rigid holder 14 is approximately perpendicular to the axis of the tightly bound illuminated fibers 12. The fiber holder 14 is positioned on or within the housing 20 in such a manner so that the holder 14 can move freely through its entire range of motion without coming into contact with the housing 20. The housing 20 can be a variety of shapes, and can be a single board, plate, box, cylinder, cone, tube, action figure, or other desired structure.

The rigid fiber holder 14 can be freely connected to an actuator rod 22 that moves back and forth on or within the housing 20 with a push pull motion. As shown in FIG. 1, one end of the actuator rod 22 is connected to the fiber holder 14, and the opposite end of the actuator rod 22 is freely mounted non-centrally to a cam wheel 24 rotating about an axis. The cam wheel 24 can be driven by means of a motor attached to the housing 20. Alternatively, the cam wheel 24 can be freely mounted to the housing 20 and driven by means of a gear, sprocket, pulley, hand crank, motor or any combination thereof.

The rotation of the cam wheel 24 through the actuator rod 22, to the rigid holder 14 and fibers 12 causes the holder 14 and fibers 12 to travel back and forth about the pivot point axis 18 so as to allow the display end 12b of the fiber(s) 12 to shake back and forth along a line approximately perpendicular to the axis of the tightly bound illuminated optical fibers 12, or parallel to a line that is approximately perpendicular to the axis of the tightly bound illuminated fibers 12, creating random and constantly changing single or multi-colored light display patterns.

An optical fiber display device according to another embodiment of the invention is illustrated in FIG. 2, and shown generally at reference numeral 50. This embodiment 50 of an optical fiber display device utilizes agitation oscillation. The device 50 comprises one or more varying length fiber optic strands 52, either individual or in bundles, with one end 52a of each strand 52 or bundle being tightly bound inside a rigid holder 54, or extending slightly beyond the rigid holder 54, hereby referred to as the illuminated end 52a. The other end 52b of the fiber optic strand(s) 52 are unrestrained and allowed to move freely about, hereby referred to as the display end 52b of the strand(s) 52.

In addition to the illuminated fiber end(s) 52a, the rigid holder 54 contains one or more illuminated light source(s) 56 such as an incandescent bulb, LED, laser diode, mirror, prism, lens, or array thereof for each individual fiber 52 or bundle of fibers 52. The light source 56 can be mounted within the holder 54 and oriented in such a way as to expose and illuminate the rigidly bound fiber end(s) 52a, causing light to be emitted from the display end 52b of the fiber(s) 52. The fiber holder 54 can also contain a colored transparent filter placed between the light source 56 and illuminated fiber ends 52a so as to add one or more colors to the fiber display while incorporating a single light source 56.

Alternatively, the tightly bound illuminated fiber end(s) 52a can be exposed to and illuminated by a stationary light source 56 such as an incandescent bulb, LED, laser diode, mirror, prism, lens, or array thereof affixed to a rigid housing 60. As the holder 54 is caused to move throughout its range of motion, the illuminated fiber ends 52a are exposed to the stationary light source, causing light to be emitted from the display end 52b of the fiber(s) 52. This configuration allows for color changes within individual fiber(s) 52 as they sweep across a multi-colored light source, and reduces the weight of the moving rigid holder 54.

As shown in FIG. 2, the rigid holder 54 can be freely secured to a pivot point axis 58 that is attached to or part of a housing 60. The housing 60 can be a variety of shapes and structures, such as a single board or plate, a box, cylinder, cone, tube, or toy action figure. The pivot point axis 58 within the rigid fiber holder 54 is non-parallel to the axis of fibers 52 within the rigid holder 54. Preferably, the axis 58 within the rigid holder 54 is approximately perpendicular to the tightly bound illuminated end 52a of the fiber(s) 52.

The rigid fiber holder 54 is positioned on or within the housing 60 in such a manner so that the rigid holder 54 can move freely about, without coming into contact with the housing 60 throughout its entire range of motion. The fiber holder 54 can include a channel 55, shaped and positioned in such a way as to allow a cam wheel 62 to rotate inside of and come into contact with the interior of the holder 54 causing movement of the holder 54 and illuminated fibers 52.

The cam wheel 62 can be driven by means of a drive motor 64 attached to the housing 60. Alternatively, the cam wheel can be freely mounted to the housing 60 and driven by means of a gear, sprocket, pulley, hand crank, motor or combination thereof. The rotation of the cam wheel 62, by coming in contact with and agitating the rigid holder 54 causes the holder 54 to move about either a single axis, or multiple axes, which in turn causes the display ends 52b of the fiber(s) 52 to move about, creating random and constantly changing single or multi-colored light display patterns.

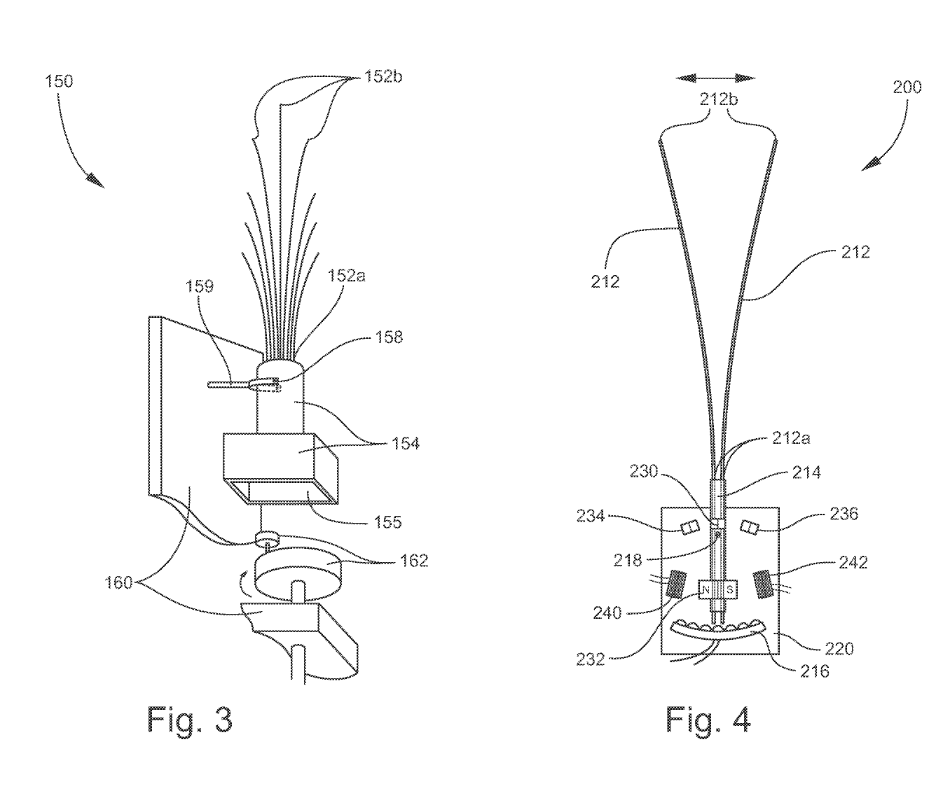

In an alternative embodiment utilizing oscillation agitation illustrated in FIG. 3 and shown generally at reference numeral 150, the rigid holder 154 can be freely secured to a first pivot point axis 158 that is also freely attached to a second pivot point axis 159 within the housing 160. Both axes 158, 159 within the rigid holder 154 are non-parallel to the axis of fibers 152 within the rigid holder 154. Preferably, the axes 158, 159 are approximately perpendicular to the tightly bound illuminated end 152a of the fiber(s) 152. This method of attachment acts as a u-joint, allowing free travel of the rigid holder 154 in two directions simultaneously, which in turn creates additional display patterns and visual effects giving the rigid holder 154 and fiber(s) 152 the ability to move about through a two-dimensional range of motion.

The rigid fiber holder 154 is positioned within the housing 160 in such a manner so that the rigid holder 154 can move freely about, without coming into contact with the housing 160 throughout its entire range of motion. The fiber holder 154 includes a channel 155, shaped and positioned in such a way as to allow a cam wheel unit 162 to rotate inside of and come into contact with the interior of the holder 154 causing movement of the holder 54 and illuminated fibers 52.

Alternatively, the rigid holder 154 can be attached at one or more points to a flexible membrane, springs, or material in such a way as to allow two-dimensional movement of the rigid holder 154 about multiple axes that are perpendicular to the tightly bound illuminated end 152a of the fiber(s) 152. This method of attachment is similar to how a speaker cone is attached to its speaker housing by means of a flexible foam membrane.

An optical fiber display device according to another embodiment of the invention is illustrated in FIG. 4, and shown generally at reference numeral 200. This embodiment 200 of the invention utilizes voice coil motor oscillation. The device 200 comprises a plurality of varying length fiber optic strands 212, either individual or in bundles with one end 212a of each strand 212 terminating and being bound tightly inside a rigid holder 214, hereby referred to as the illuminated end 212a of the fibers 212. The other end 212b of the fiber(s) 212 are unrestrained and allowed to move freely about, hereby referred to as the display end 212b of the fiber(s) 212

The tightly bound illuminated fiber(s) 212 can be exposed to and illuminated by a stationary light source, such as an LED array 216 affixed to a rigid housing 220. Alternatively, the light source can be an incandescent bulb, LED, laser diode, mirror, prism, lens, or array thereof. As the holder 214 is moved throughout its range of motion, the illuminated fiber ends 212a are exposed to the stationary light source 216, causing light to be emitted from the display end 212b of the fiber(s) 212. This method of illumination allows for color changes within individual fiber(s) 212 as they sweep across a multi-colored light source, and reduce the weight of the moving rigid holder 214.

Alternatively, the rigid holder 214 can contain the illuminated light source 216. The light source 216 can be mounted within the holder 214, and oriented in such a way as to expose and illuminate the rigidly bound fiber end(s) 212a, causing light to be emitted from the display end 212b of the fiber(s) 212. The fiber holder 214 can also contain a colored transparent filter placed between the light source 216 and illuminated fiber(s) 212 so as to add one or more colors to the fiber display while utilizing a single light source 216.

The rigid holder 214 is freely secured to a pivot point axis 218 attached to, or part of the housing 220. This pivot point axis 218 within the rigid holder 214 is non-parallel to the axis of fibers 212 within the rigid holder 214. Preferably, the axis 218 within the rigid holder 214 is approximately perpendicular to the tightly bound illuminated end 212a of the fiber(s) 212.

The fiber holder 214 can be positioned on or within the housing 220 in such a manner so that the holder 214 can move freely through its entire range of motion without coming into contact with the housing 220. The housing 220 may be shaped in any way and can be comprised of a single board, plate, box, cylinder, cone, tube, action or figure.

As shown in FIG. 4, a plurality of magnetic objects, such as permanent magnets 230, 232 are affixed to the rigid holder 214. A pair of permanent magnets 234, 236, and a pair of electromagnetic coils of wire 240, 242 are affixed to the housing 220. One of the magnets 230, 232 affixed to the rigid holder 214 is positioned to react magnetically by means of repulsion from the corresponding magnets 234, 236 affixed to the housing 220. The other magnet affixed to the rigid holder 214 is positioned to react magnetically by means of attraction/repulsion to the electromagnetic coils of wire 240, 242 on the housing. This maximizes the magnetic effect.

An electrical signal can flow through the wire coils 240, 242, and create a magnetic field within and around the coils 240, 242, turning the coils 240, 242 into electromagnets which in turn create magnetic attraction/repulsion forces, causing the rigid holder 214 to react, and move upon its axis 218 within the housing 220 in a manner that corresponds to the polarity, strength and frequency of the electrical signal.

The coils 240, 242 can be energized by means of an electrical signal supplied by an electrical source, such as an amplifier, signal generator, microphone, speaker output, AC line voltage, and/or DC power supply.

In this embodiment 200, no cam wheel or actuator rod is required to keep the rigid fiber holder 214 in a given place when the device 200 is powered off. Without an electrical signal to the wire coil(s) 240, 242, the rigid holder 214 is free to travel about. As such, one or more springs or permanent magnets can be attached on or between the housing 220 and rigid holder 214 to establish a rough central point “home position” of travel, giving an amount of support to the rigid holder 214 when powered off or operating at higher frequencies.

In this embodiment 200, having no cam wheel or actuator rod keeps the rigid fiber holder 214 in a given place whether powered on or off. There is also no limit to the overall travel of the rigid holder 214 in either direction through its range of motion, thus one or more springs or permanent magnets can be attached on or between the housing 220 and rigid holder 214 in such a way as to provide a “stop”, or “limit” to the maximum amount of travel of the rigid fiber 214 holder in either direction.

Electrical signals conducting through one or more wire coil(s) 240, 242 create changing magnetic fields in the wire coil(s) 240, 242 and cause magnetic attraction/repulsion forces between the coil(s) 240, 242 and magnets 230, 232, 234, 236 mounted to the rigid holder 214 and housing 220, causing the rigid holder 214 and fiber(s) 212 to move back and forth in response to those signals.

In this voice coil motor method of oscillation, the housing 220, which has permanently attached magnets 230, 232, 234, 236 and/or coils 240, 242, and freely holds the rigid fiber holder 214 and its own magnets 230, 232, 234, 236, can act as a sub-housing and be freely attached to a second rigid main housing. The sub-housing 220 can then be rotated or oscillated about a second axis that is contained on or in the main housing. The main housing and sub-housing may be shaped in any way and can comprise a single board or plate, box, cylinder, cone, tube, and/or action figure. The sub-housing may be caused to oscillate or rotate on its axis by means of a cam wheel and channel, actuator rod, motor, gear, pulley, sprocket, voice coif motor, hand crank, or combination thereof.

This second axis/sub-housing method allows the display end(s) 212b of the fiber(s) 212 to move about two axes simultaneously, creating constantly changing single or multi-colored light display patterns that respond to a given electrical signal and have the ability to offer a rough but accurate visual display of sound—similar to audio waves displayed on an oscilloscope.

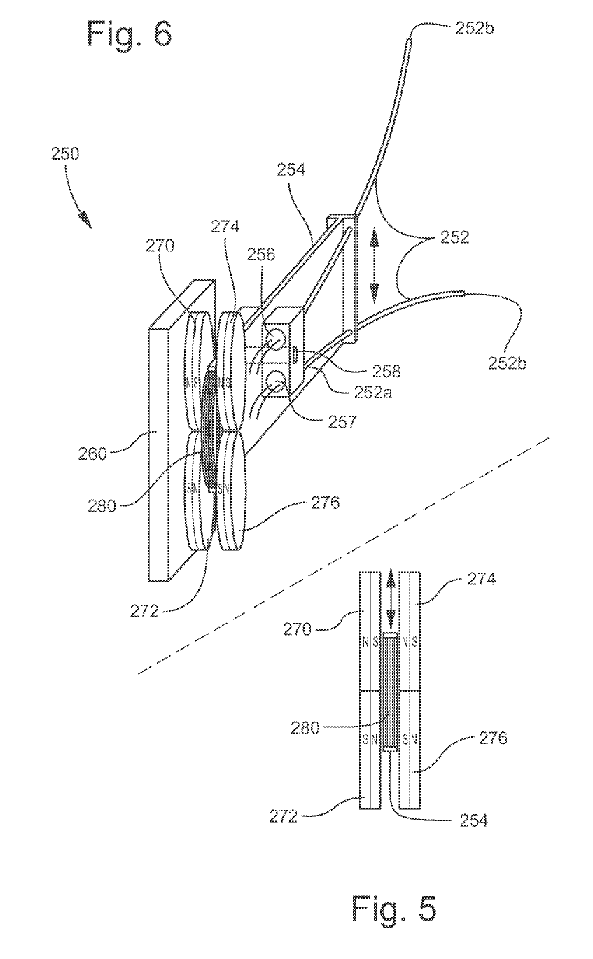

In an alternative embodiment illustrated in FIGS. 5-6, and shown generally at reference numeral 250, a rigid holder 254 can contain an illuminated light source, such as a plurality of LEDs 256, 257. The LEDs 256, 257 can be mounted within the holder 254, and oriented in such a way as to expose and illuminate the rigidly bound fiber end(s) 252a, causing light to be emitted from the display end 252b of the fiber(s) 252. The fiber holder 254 can also contain a colored transparent filter placed between the LEDs 256, 257 and illuminated fiber(s) 252 so as to add one or more colors to the fiber display 250 while utilizing a single light source.

As shown in FIG. 6, a four permanent magnets 270, 272, 274, 276 are attached to the housing 260. An electromagnetic wire coil 280 is attached to the rigid holder 254. An electrical signal flows through the wire coil 280 and creates a magnetic field within and around the coil 280, creating magnetic attraction/repulsion forces between the magnets 270, 272, 274 and 276, and the coil 280, causing the rigid holder 254 to move upon a pivot point axis 258.

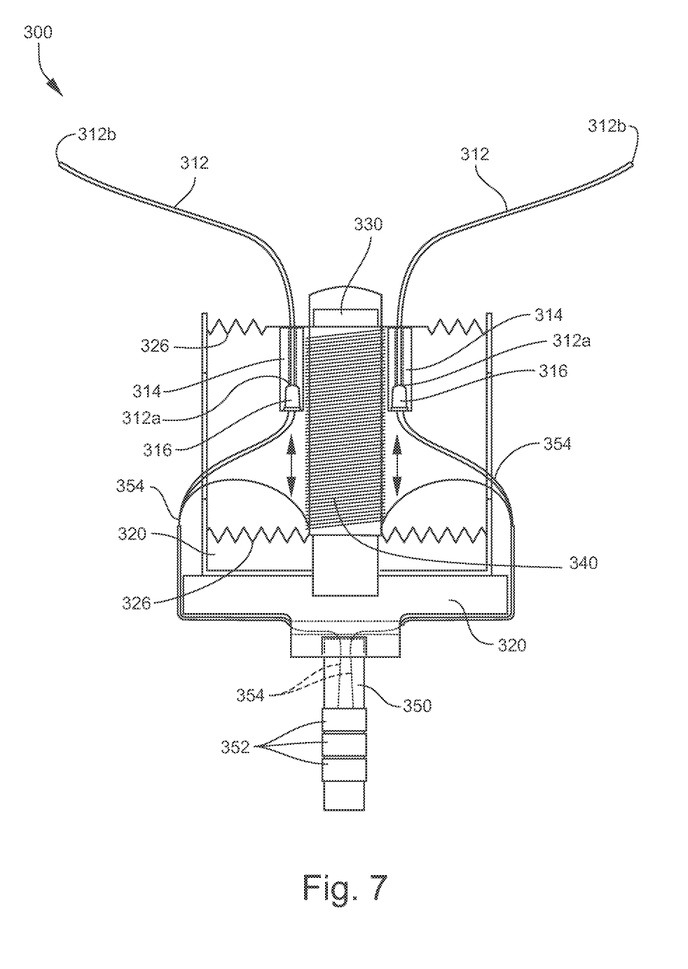

A display device according to another embodiment of the invention is illustrated in FIG. 7, and shown generally at reference numeral 300. This embodiment 300 of the invention utilizes linear voice coil motor oscillation or speaker motor oscillation. The device 300 is comprised of one or more varying length fiber optic strands 312, either individual or in bundles with one end of each strand, or bundle terminating and being bound tightly inside a rigid holder 314, hereby referred to as the illuminated end of the fibers 312a. The other end 312b of the fiber optic strand(s) 312 being unrestrained and allowed to move freely about, hereby referred to as the display end 312b of the fiber(s) 312.

Each rigid holder 314 contains an illuminated light source 316 such as an incandescent bulb, LED, laser diode, mirror, prism, lens, or array thereof for the individual fiber(s). The light source 316 can be mounted within the holder 314 and oriented in such a way as to expose and illuminate the rigidly bound fiber end(s) 312a, causing light to be emitted from the display end 312b of the fiber(s) 312. The fiber holder 314 can also contain a colored transparent filter placed between the light source 316 and illuminated fiber(s) 312 so as to add one or more colors to the fiber display 300 while incorporating a single light source 316.

Alternatively, the tightly bound illuminated fiber(s) 312 can be exposed to and illuminated by a stationary light source such as an incandescent bulb, LED, laser diode, mirror, prism, lens, or array thereof affixed to a rigid housing 320. As the holder 314 is caused to move throughout its range of motion, the illuminated fiber ends 312a will be exposed to the stationary light source, causing light to be emitted from the display end 312b of the fiber(s) 312. This method of illumination allows for color changes within individual fiber(s) 312 as they sweep across a multi-colored light source, and reduce the weight of the moving rigid holder 314.

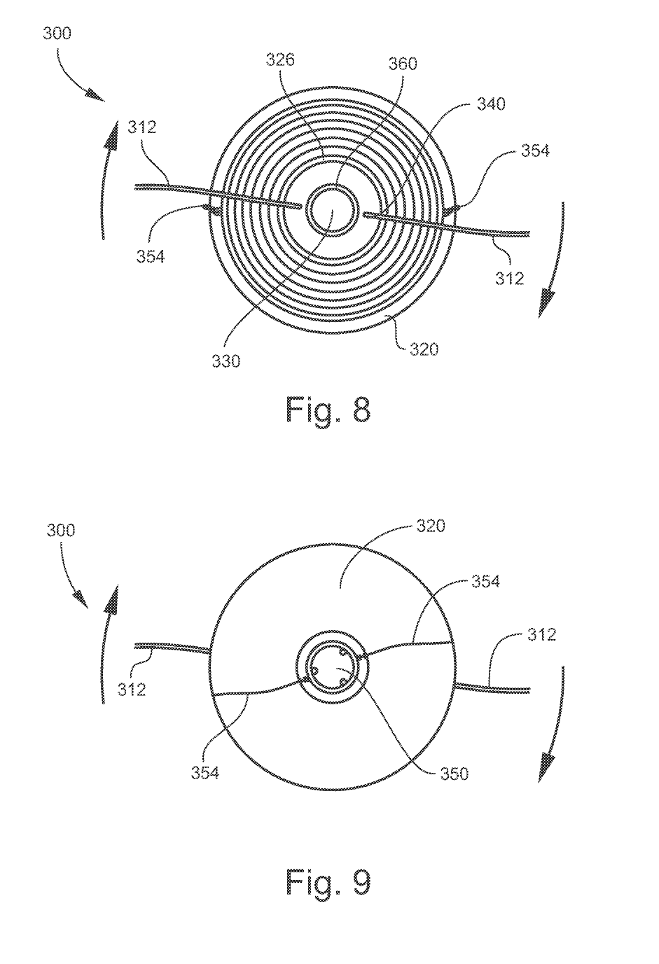

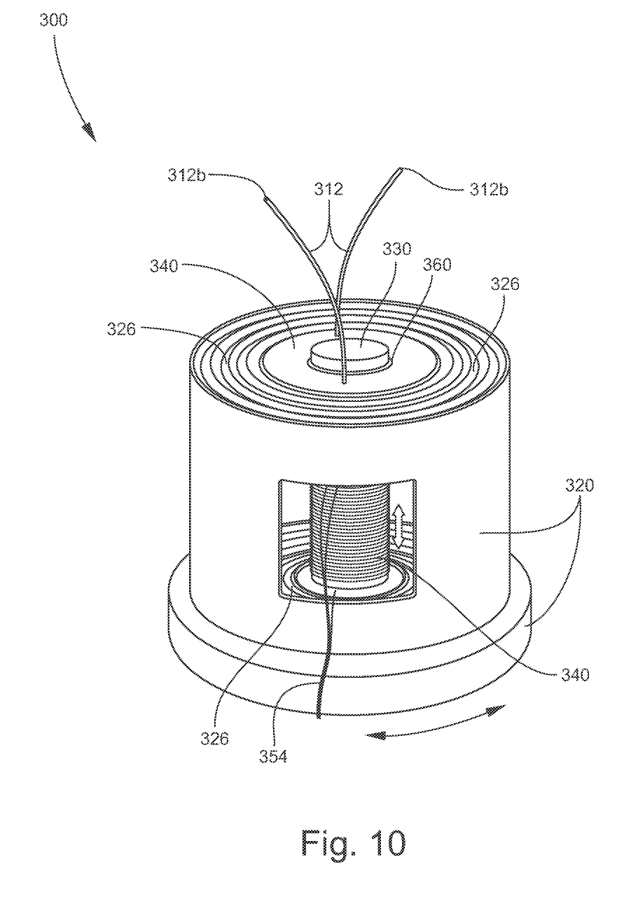

The rigid holders 314 and fibers 312 can be mounted to a magnet, speaker cone, coil housing, or coil(s) located axially either closely within or around one or more cylindrical permanent magnets or coils that is also mounted axially within the linear voice coil motor housing 320. As shown in FIG. 7, the rigid holders 314 and fibers 312 can be mounted proximate a magnet 330 and electromagnetic wire coil 340. This freely moving magnet 330 or electromagnetic wire coil(s) 340 are axially attached to the inner or outer circumference of one or more flexible members such as speaker spiders 326. Alternatively, the flexible members can be a membrane or spring assembly. The flexible member 326 has its opposite circumference mounted axially to the linear voice coil motor housing 320. This relationship allows the rigid holder 314 and fibers 312 to move freely in a one-dimensional motion along the axis of the housing 320 and permanent magnet(s) 330. The rigid holder 314 and fibers 312 are oriented either above, below, or extending through the magnet 330 in such a manner as to allow the illuminating fiber ends 312a to extend in a general direction away from the axial center of the voice coil motor. As shown in FIGS. 8 and 10, an air gap 360 exists between the magnet 330 and the speaker spiders 326.

An axis shaft 350 is functionally connected to the voice coil motor and attached to the housing 320. Brush contacts 352 are positioned on the axis shaft 350. Wiring 354 connected to the motor extends through the interior of the shaft 350 into the housing 320 and connects to the coil(s) 340 and the light source 316.

Electrical signals conducting through the wire coil(s) 340 create changing magnetic fields in the coil(s) 340 and cause magnetic attraction/repulsion forces between the coil(s) 340 and magnet(s) 330 mounted to the housing, causing the rigid holder 314 and fiber(s) 312 to move back and forth in response to those signals.

In this linear voice coil motor method of oscillation the housing 320, which has axially mounted magnets 330 and coil(s) 340, and freely holds the rigid fiber holder 314 and its own magnet(s) 330 and coil(s) 340, can act as a sub-housing and be freely and axially attached to a second rigid main housing by its axis. The sub-housing can then be rotated or oscillated about the axis that is contained on or in this main housing. The housing and sub-housing may be shaped in any way and can comprise, but is not limited to, a single board or plate, box, cylinder, cone, tube, or action figure. The sub-housing may be caused to oscillate or rotate on its axis by means of a cam wheel and channel, actuator rod, motor, gear, pulley, sprocket, voice coil motor, hand crank, or combination thereof.

This second axis/sub-housing method allows the display end(s) 312b of the fiber(s) 312a to move about two axes simultaneously, creating constantly changing single or multi-colored light display patterns that respond to a given electrical signal and have the ability to offer a rough but accurate visual display of sound—similar to audio waves displayed on an oscilloscope.

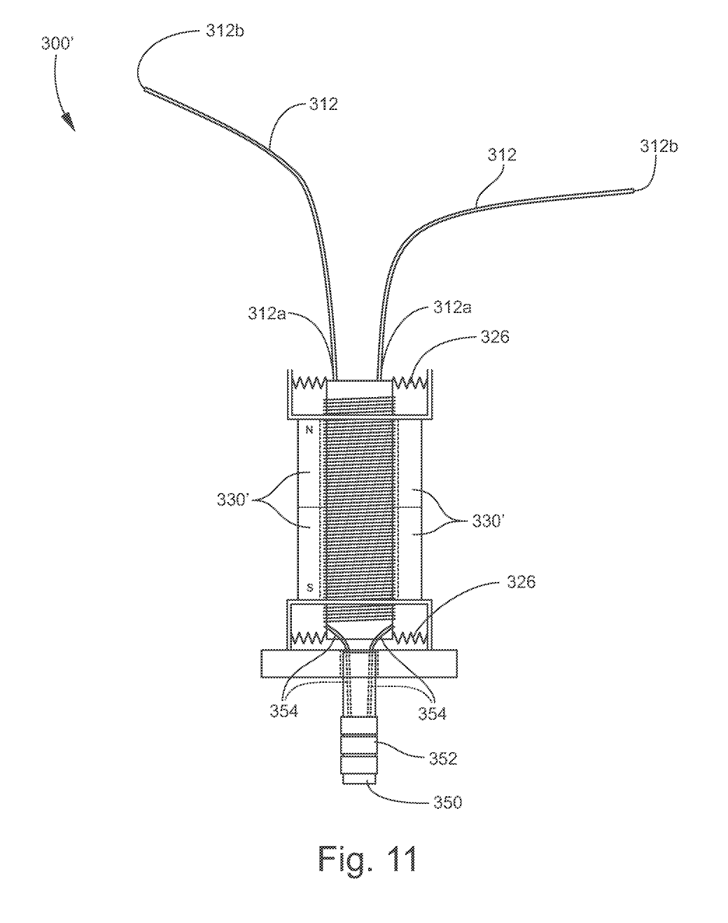

In an alternative embodiment illustrated in FIG. 11, and shown generally at reference numeral 300′, cylindrical magnets 330′ are positioned adjacent the coil(s) 340.

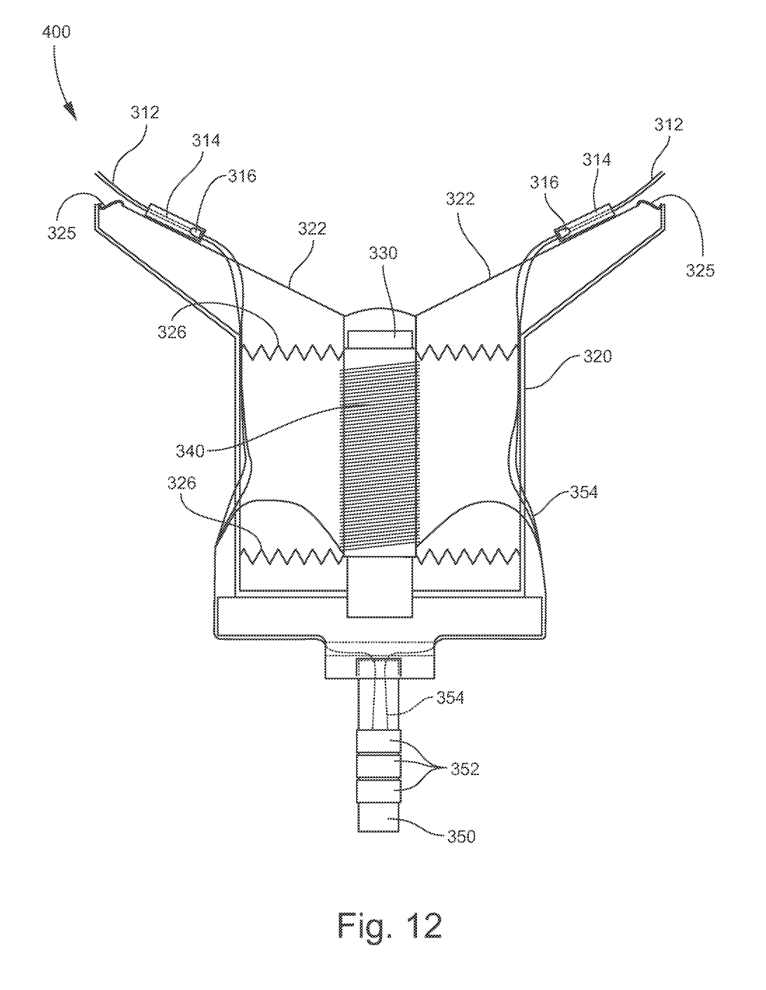

In an alternative embodiment illustrated in FIG. 12 and shown generally at reference numeral 400, the cylindrical magnet 330 and electromagnetic wire coil 340 are mounted axially within the linear voice coil motor housing 320. The housing 320 includes a speaker cone 322. Flexible membranes 325 are positioned on the speaker cone 322. The rigid holder 314 and fibers 312 can be mounted to the cone 322, and is located proximate the cylindrical magnet 330 and coil 340 that is also mounted axially within the linear voice coil motor housing 320. Alternatively, the holder 314 and fibers 312 can be attached to the magnet 330, coil 340 or housing 320.

The freely moving magnet or coil 340 is axially attached to one or more flexible members such as speaker spiders 326, or alternatively, to a membrane or spring assembly. The cylindrical magnet 330 is attached to the housing 320. The flexible member 326 has its opposite circumference mounted axially to the linear voice coil motor housing 320. This relationship allows the rigid holder and fibers attached to the magnet, or coil(s), coil mount, and speaker cone to move freely in a one-dimensional motion along the axis of the housing and permanent magnet(s). The rigid holder and fibers shall be oriented either above, below, or extending through the magnet, magnet holder, speaker cone/coil housing in such a manner as to allow the illuminating fiber ends to extend in a general direction away from the axial center of the voice coil motor.

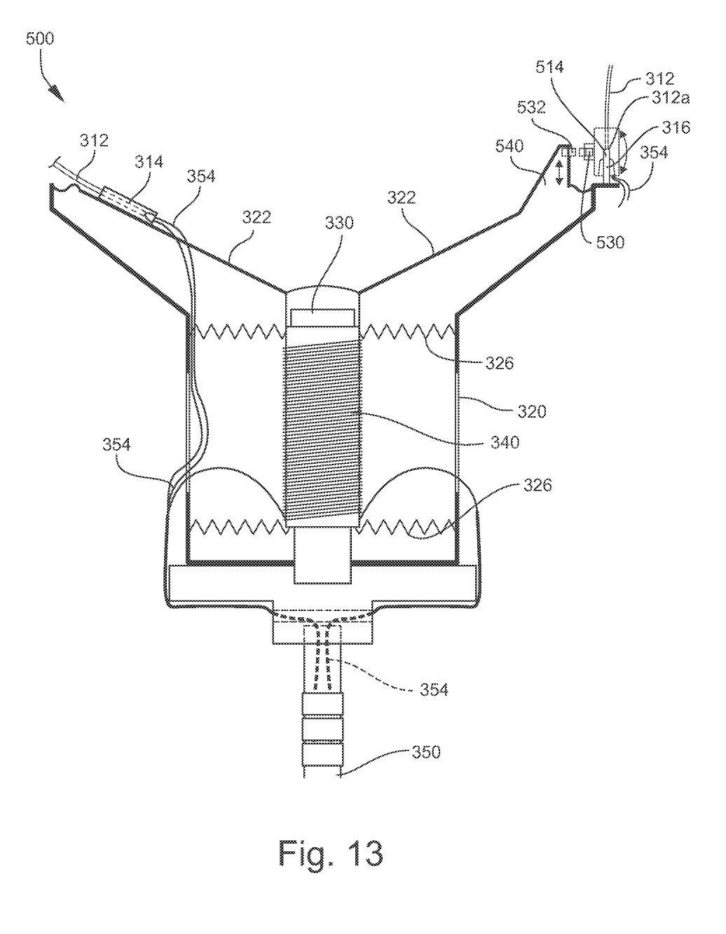

In another embodiment illustrated in FIG. 13 and shown generally at reference numeral 500, at least one rigid fiber holder 514 can be freely secured to a pivot point axis 518 that is attached to, or part of the housing 320 and this pivot point axis 518 within the rigid holder 514 is not parallel to the axis of fibers 312 within the rigid holder 518. Preferably, the axis 518 within the rigid holder is approximately perpendicular to the tightly bound illuminated end 312a of the fiber(s) 312. The housing can be shaped in any way, and can comprise, but is not limited to a single board or plate, a box, cylinder, cone, tube, action figure.

At least one permanent driven magnet 530 can be attached to the rigid holder 518 and positioned in such a way as to react magnetically by means of attraction/repulsion, to one or more corresponding permanent driving magnets 532, which are permanently affixed to a moveable member such as part 540 of the speaker cone 322, or alternatively a coil housing, coil(s), or second permanent magnet, which is located axially either closely within or around one or more cylindrical permanent magnets or coils that is also mounted axially within the linear voice coil motor housing 320. This freely moving driving magnet, magnet holder, speaker cone, coil housing, or coil(s) shall be axially attached to the inner or outer circumference of one or more flexible members such as a speaker spider, membrane or spring assembly. The flexible member having its opposite circumference mounted axially to the linear voice coil motor housing 320. This relationship allows the magnet(s), or coil(s), coil mount, speaker cone, and driving magnet to move freely in a one-dimensional motion along the axis of the housing and permanent magnet(s) 530. This one-dimensional linear motion of the driving magnet(s) in turn causing a corresponding motion by means of magnetic coupling to the driven magnet and rigid holder 514 about its pivot point axis 518.

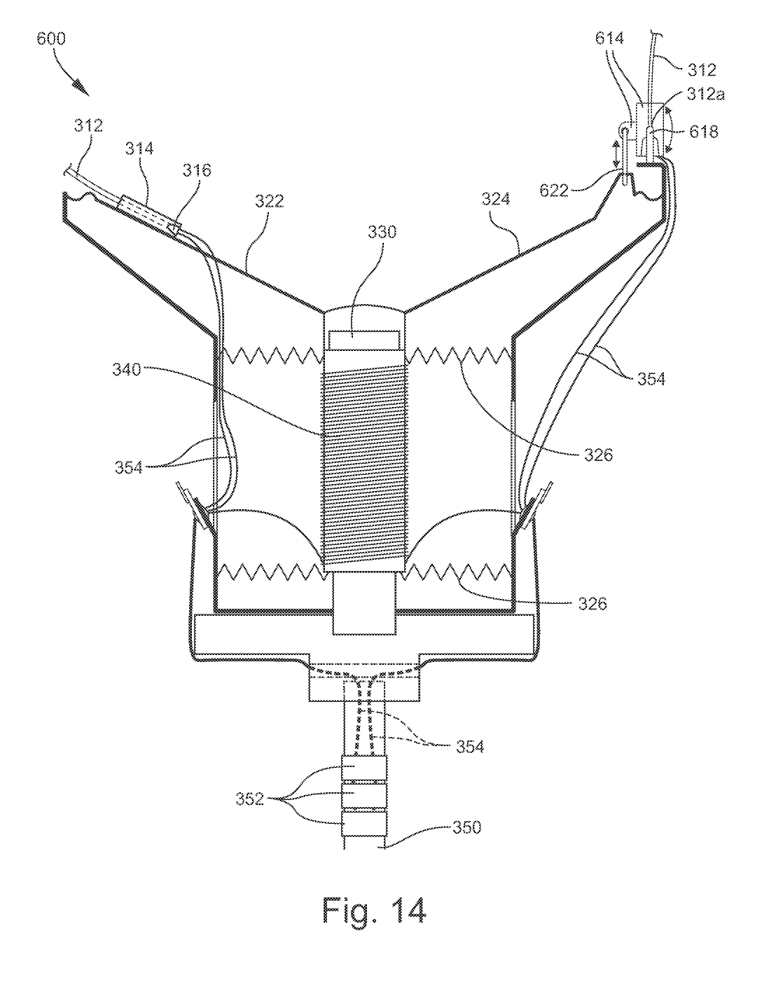

In another embodiment of the invention illustrated in FIG. 14, and shown generally at reference numeral 600, at least one rigid fiber holder 614 is freely secured to a pivot point axis 618 that is attached to, or part of the housing 320 and this pivot point axis 618 is not parallel to the axis of fibers 312 within the rigid holder 618. Preferably, the axis 618 within the rigid holder is approximately perpendicular to the tightly bound illuminated end 312a of the fiber(s) 312. The pivot point axis 618 of the rigid holder 614 is freely connected to an actuator rod 622 connected to the housing 320. The rod 622 moves back and forth, and is driven by the movement of the speaker cone 322.

The motion of the actuator rod 622, causes the holder 614 and fiber(s) 312 to travel back and forth about the pivot point axis 618 so as to allow the fiber(s) 312 to shake back and forth along a line approximately perpendicular to the axis of the tightly bound illuminated optical fibers 312a, creating random and constantly changing single or multi-colored light display patterns.

An optical fiber display device and methods for oscillating optical fibers are described above. Various changes can be made to the invention without departing from its scope. The above description of the preferred embodiments and best mode of the invention are provided for the purpose of illustration only and not limitation—the invention being defined by the following claims and equivalents thereof.

What is claimed is:

1. An optical fiber display apparatus comprising:
(a) a housing;
(b) a holding member moveable about a pivot point axis functionally connected to the housing;
(c) at least one fiber optic strand having a first end attached to the holding member and a second end unrestrained, the at least one fiber optic strand defining a longitudinal axis, and wherein the pivot point axis of the holding member is non-parallel to the fiber strand axis whereby movement of the holding member about the pivot point axis causes the second unrestrained end of the fiber strand to move back and forth along a line that is non-parallel to the longitudinal fiber strand axis; and
(d) a light source illuminating the first end of the fiber strand, whereby light emits from the second end of the fiber strand.

2. An apparatus according to claim 1, wherein the pivot point axis of the holding member is substantially perpendicular to the fiber strand axis whereby movement of the holding member about the pivot point axis causes the second unrestrained end of the fiber strand to move back and forth along a line that is substantially perpendicular to the longitudinal fiber strand axis.

3. An apparatus according to claim 1, wherein the at least one fiber optic strand comprises a plurality of fiber optic strands.

4. An apparatus according to claim 1, wherein the at least one fiber optic strand comprises a plurality of fiber optic strands bundled together, and at least one of said plurality of fiber optic strands is attached to the holding member.

5. An apparatus according to claim 1, further comprising drive means for moving the holding member about the pivot point axis.

6. An apparatus according to claim 5, wherein the drive means comprises one or more selected from the group consisting of an actuator rod, cam wheel, gear, sprocket, pulley, hand crank, motor, and magnet.

7. An apparatus according to claim 1, further comprising an actuator rod and a rotatable cam wheel, the actuator rod having a first end connected to the holding member and a second end mounted to the cam wheel, wherein rotation of the cam wheel causes the holding member to move back and forth about the pivot point axis whereby the second end of the fiber strand moves back and forth.

8. An apparatus according to claim 1, further comprising a colored transparent filter positioned between the light source and the first end of the fiber strand whereby the second end of the fiber strands emits at least one colored light.

9. An apparatus according to claim 1, wherein the light source comprises one or more selected from the group consisting of an incandescent bulb, light emitting diode, laser diode, mirror, prism, lens, and array.

10. An apparatus according to claim 1, wherein the light source is positioned with the holding member.

11. An apparatus according to claim 1, wherein the housing comprises one or more selected from the group consisting of a board, plate, box, cylinder, cone, tube, and action figure.

12. An optical fiber display apparatus comprising:
(a) a housing;
(b) a holding member defining a channel and moveable about a first pivot point axis functionally connected to the housing;
(c) at least one fiber optic strand having a first end attached to the holding member and a second end unrestrained, the at least one fiber optic strand defining a longitudinal axis, and wherein the pivot point axis of the holding member is non-parallel to the fiber strand axis whereby movement of the holding member about the pivot point axis causes the second unrestrained end of the fiber strand to move back and forth along a line that is non-parallel to the longitudinal fiber strand axis; and
(d) a light source illuminating the first end of the fiber strand, whereby light emits from the second end of the fiber strand.

13. An apparatus according to claim 12, further comprising a cam wheel positioned within the channel defined by the holding member, wherein rotation of the cam wheel causes the cam wheel to contact and move the holding member.

14. An apparatus according to claim 13, further comprising means for moving the cam wheel selected from the group consisting of a drive motor, gear, sprocket, pulley, and hand crank.

15. An apparatus according to claim 12, further comprising a second pivot point axis having a first end connected to the first pivot point axis and a second end connected to the housing, the second pivot point axis positioned non-parallel to the fiber strand axis, and wherein the holding member is movable two directions simultaneously, whereby the fiber strand is movable about a two-dimensional range of motion.

16. An apparatus according to claim 15, wherein the first pivot point axis and the second pivot point axis are positioned substantially parallel to the fiber strand axis.

17. An optical fiber display apparatus comprising:
(a) a housing;
(b) a holding member moveable about a pivot point axis functionally connected to the housing;
(c) at least one fiber optic strand having a first end attached to the holding member and a second end unrestrained, the at least one fiber optic strand defining a longitudinal axis, and wherein the pivot point axis of the holding member is non-parallel to the fiber strand axis whereby movement of the holding member about the pivot point axis causes the second unrestrained end of the fiber strand to move back and forth along a line that is non-parallel to the longitudinal fiber strand axis;
(d) a light source illuminating the first end of the fiber strand, whereby light emits from the second end of the fiber strand; and
(e) means for moving the holding member about the pivot point axis.

18. An apparatus according to claim 17, wherein the means for moving the holding member comprises at least one magnet.

19. An apparatus according to claim 17, wherein the means for moving the holding member comprises at least one electromagnetic wire coil, and further comprising an electrical source for delivering an electrical signal through said at least one electromagnetic wire coil to create a magnetic field causing the holding member to move about the pivot point axis.

20. An apparatus according to claim 19, wherein the electrical source comprises one or more selected from the group consisting of an amplifier, signal generator, microphone, speaker output, AC line voltage, and DC power supply.
